(19) United States
(12) Patent Application Publication
(10) Pub. No.: US 2009/0295270 A1
(43) Pub. Date: Dec. 3, 2009

(54) Device with electron beam excitation for making white light source

(75) Inventors: Wade-Lee Wang, Taipei (TW); Wen-Hsien Cheng, Taipei (TW); Tzung-Han Yang, Taipei (TW)

Correspondence Address: BACON & THOMAS, PLLC, 625 SLATERS LANE, FOURTH FLOOR, ALEXANDRIA, VA, 22314-1176, US

(73) Assignee: Tatung Company, Taipei (TW)

(21) Appl. No.: 12/285,538

(22) Filed: Oct. 8, 2008

(30) Foreign Application Priority Data
May 27, 2008 (TW) 097119494

(51) Int. Cl. H01J 1/62

(52) U.S. Cl. 313/483

(57) ABSTRACT

The present invention relates to a device with electron beam excitation for making a white light source. The device with electron beam excitation comprises: an electron emissive layer for providing an electron beam; and a fluorescent layer comprising a fluorescent powder, wherein the fluorescent powder comprises at least four elements of Zn, S, Se and O. The fluorescent layer can be excited by an electron beam and then emit white light. Accordingly, the present invention can provide a white light source with high color rendering index.

### BACKGROUND OF THE INVENTION

1. Field of the Invention

The present invention relates to a device with electron beam excitation and, more particularly, to a device with electron beam excitation for making a white light source.

2. Description of Related Art

A backlight module is one of the key components for a liquid crystal display. Since liquid crystal does not emit light by itself, a backlight module is used to provide light with sufficient brightness and uniformity so as to produce viewable images on an LCD. Currently, a field emission lamp is developed to replace a cold cathode fluorescent lamp owing to the former's advantages, such as its simple structure, high brightness, power saving feature, compact volume and its ability to satisfy the requirements of flatness and large scale. Moreover, in addition to backlight modules for LCDs, a field emission lamp can further be applied in light source systems for decoration, lighting or indication.

FIG. 1 is a schematic view for illustrating the work principle of a field emission lamp. A field emission lamp mainly includes a cathode electrode 111, an electron emissive layer 112, an anode electrode 121 and a fluorescent layer 122. Accordingly, when a driving voltage is applied between the cathode electrode 111 and the anode electrode 121, an electric field is formed therebetween and thus the tunnel effect occurs whereby electrons are released from the electron emissive layer 112. Then, the released electrons will impact the fluorescent layer 122 to allow the fluorescent layer 122 to emit cathodoluminescence. In addition to the electron emissive layer 112, a gate electrode 113 can be further included above the cathode electrode 111 to accurately control emission of electrons and increase the electron current density. Herein, the gate electrode 113 and the cathode electrode 111 can be electrically separated from each other by the insulating layer 114.

Accordingly, it can be known that a field emission lamp uses electron beams to excite the fluorescent layer and then light is generated. So far, a fluorescent layer for producing white light generally consists of two or more kinds of fluorescent powders, such as red, green and blue fluorescent powders mixed with each other. Thereby, the color rendering index of a traditional white light source is significantly influenced by color combination and thus it is difficult to achieve uniformity in color.

### SUMMARY OF THE INVENTION

The object of the present invention is to provide a method for making a white light source by means of a device with electron beam excitation, in which a novel fluorescent powder consisting of a single component is used to directly produce white light without the need for a process for combining the novel fluorescent powder with other fluorescent powders. Accordingly, the process for color combination can be omitted. Also, in mass production, the color purity of light can be maintained in high quality. In comparison to the mixture of various fluorescent powders, the novel fluorescent powder can produce a white light source with improved color rendering index since the novel fluorescent powder has a wide range of emission spectrum and a uniform distribution of an illumination strength.

To achieve the aforementioned or other objects, the present invention provides a method for making a white light source by a device with electron beam excitation, in which an electron beam is used to excite a kind of fluorescent powder so that the fluorescent powder emits white light. Herein, the fluorescent powder includes at least four elements of Zn, S, Se and O. Accordingly, white light of continuous wavelength from 470 nm to 670 nm is emitted by the aforementioned method.

The fluorescent powder used in the present invention is well known and can be prepared by a solid-reaction method.

In the aforementioned method for making a white light source, applying a driving voltage can generate the electron beam. Preferably, the driving voltage is 500˜25000 V. In addition, the electron beam can impact the fluorescent powder in vacuum. Preferably, the degree of vacuum is in a range from 10×10⁻³ to 10×10⁻⁸.

In the aforementioned method for making a white light source, the electron beam can be released from an electron emissive layer, and the electron emissive layer can have a film structure, for example, a carbon nanotube film.

Accordingly, the present invention provides a device with electron beam excitation for making a white light source, comprising: an electron emissive layer for providing an electron beam; and a fluorescent layer comprising a fluorescent powder, wherein the fluorescent powder comprises at least four elements of Zn, S, Se and O, and the fluorescent layer is excited by the impact of the electron beam to thereby emit white light. Accordingly, the device with electron beam excitation can emit white light of continuous wavelength from 470 nm to 670 nm.

The aforementioned device can further comprise a cathode electrode and an anode electrode. Herein, the electron emissive layer is formed on the surface of the cathode electrode, and the fluorescent layer is formed on the surface of the anode electrode.

The aforementioned device can further comprise a first substrate and a second substrate. Herein, the anode electrode is formed on the surface of the first substrate, and the cathode electrode is formed on the surface of the second substrate.

In the aforementioned device, the electron beam can be produced by applying a driving voltage of 500˜25000 V. Accordingly, the electron beam can be released from the electron emissive layer by the driving voltage and then impact the fluorescent layer, so that the fluorescent layer emits white light. Herein, the electron beam can impact the fluorescent powder in a degree of vacuum that ranges from 10×10⁻³ to 10×10⁻⁸, and the electron emissive layer can have a film structure, for example, a carbon nanotube film.

Accordingly, the present invention provides a method for making a white light source by means of a device with electron beam excitation, in which a novel fluorescent powder consisting of a single component is used to directly produce white light without using a process for combining the novel fluorescent powder with other fluorescent powders. Accordingly, the process for color combination can be omitted. Also, in mass production, the color purity of light can be maintained in high quality. In comparison to the mixture of various fluorescent powders, the novel fluorescent powder can produce a white light source with improved color rendering index since the novel fluorescent powder has a wide range of emission spectrum and a uniform distribution of an illumination strength.

Other objects, advantages, and novel features of the invention will become more apparent from the following detailed description when taken in conjunction with the accompanying drawings.

### BRIEF DESCRIPTION OF THE DRAWINGS

FIG. 1 is a schematic view for illustrating the work principle of a field emission lamp;

FIG. 2 is a cross-sectional view of a device with electron beam excitation according to a preferred embodiment of the present invention;

FIG. 3 shows emission spectra of the fluorescent layer according to the present invention;

FIG. 4A is a schematic view of a device with electron beam excitation according to a preferred embodiment of the present invention; and

FIG. 4B is a schematic view of an enlarged cathode according to a preferred embodiment of the present invention.

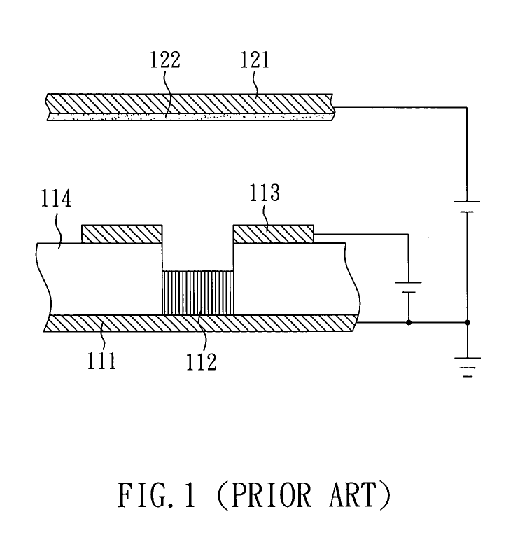

### DETAILED DESCRIPTION OF THE PREFERRED EMBODIMENT

Because the specific embodiments illustrate the practice of the present invention, a person having ordinary skill in the art can easily understand other advantages and efficiency of the present invention through the content disclosed therein. The present invention can also be practiced or applied by other variant embodiments. Many other possible modifications and variations of any detail in the present specification based on different outlooks and applications can be made without departing from the spirit of the invention.

The drawings of the embodiments in the present invention are all simplified charts or views, and only reveal elements relative to the present invention. The elements exposed in the drawings are not necessarily aspects of the practice, and quantity and shape thereof are optionally designed. Further, the design aspect of the elements can be more complex.

### Embodiment 1

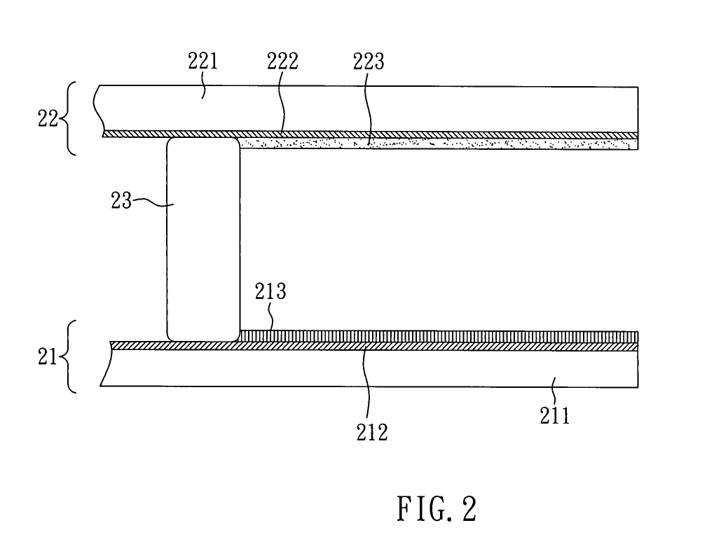

With reference to FIG. 2, there is shown a cross-sectional view of a device with electron beam excitation according to a preferred embodiment of the present invention. The device with electron beam excitation according to the present embodiment mainly includes: a cathode 21; an anode 22, disposed above the cathode 21; and a plurality of spacers 23, disposed between the anode 22 and the cathode 21. Herein, the device with electron beam excitation uses an electron beam to excite a fluorescent layer and thereby white light of continuous wavelength from 470 nm to 670 nm is emitted.

In detail, the cathode 21 of the device with electron beam excitation according to the present embodiment includes: a second substrate 211; a cathode electrode 212, formed on the surface of the second substrate 211; and an electron emissive layer, formed on the surface of the cathode electrode 212. In addition, the anode 22 of the device with electron beam excitation according to the present embodiment includes a first substrate 221, an anode electrode 222 and a fluorescent layer 223. Herein, the anode electrode 222 is formed on the surface of the first substrate 221, and the fluorescent layer 223 is formed on the surface of the anode electrode 222. The fluorescent layer 223 includes a fluorescent powder, and the fluorescent powder includes at least four elements of Zn, S, Se and O.

In the device with electron beam excitation according to the present embodiment, the degree of vacuum between the cathode 21 and the anode 22 is 10×10⁻³ to 10×10⁻⁸, and the electron emissive layer 213 is a carbon nanotube film. Accordingly, when a driving voltage of 500˜25000V is applied to form an electric field between the cathode electrode 212 and the anode electrode 222, the tunnel effect occurs so as to release electrons from the electron emissive layer 213. Then, the released electrons will impact the fluorescent layer 223 of the anode 22 to allow the fluorescent layer 223 to emit white light.

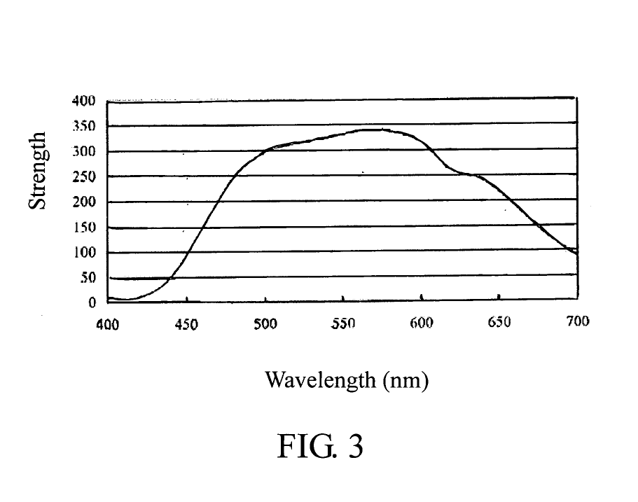

In the present embodiment, the fluorescent powder of the fluorescent layer 223 is prepared by a solid-reaction method. The fluorescent powder of the fluorescent layer 223 includes at least four elements of Zn, S, Se and O. The emission spectrum of the fluorescent layer used in the present embodiment is shown in FIG. 3. Accordingly, it can be confirmed that the fluorescent layer used in the present embodiment can be excited by an electron beam and thus emit white light of continuous wavelength from 470 nm to 670 nm.

### Embodiment 2

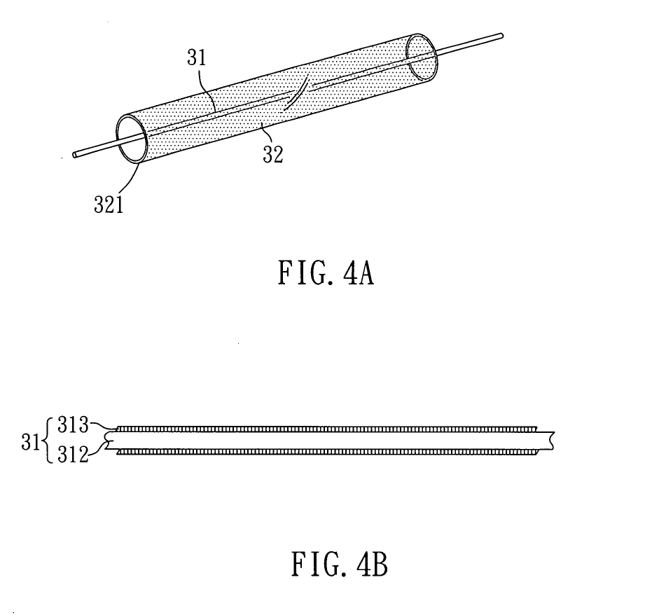

With reference to FIGS. 4A and 4B, there are shown schematic views of a device with electron beam excitation and the enlarged cathode according to the present embodiment. The device with electron beam excitation according to the present embodiment mainly includes a cathode 31 and an anode 32. In detail, the cathode 31 of the device with electron beam excitation according to the present embodiment includes a cathode electrode 312 (a metal silk) and an electron emissive layer 313 formed on the surface of the cathode electrode 312, as shown in FIG. 4B. In addition, the anode 32 of the device with electron beam excitation according to the present embodiment includes a first substrate 321 (a glass tube) and a fluorescent layer (not shown in the figure) formed on the surface of the anode electrode.

In the device with electron beam excitation according to the present embodiment, the material of the anode electrode is indium tin oxide, and the fluorescent powder of the fluorescent layer is prepared by the method as mentioned in Embodiment 1. The degree of vacuum between the cathode 31 and the anode 232 is 10×10⁻³ to 10×10⁻⁸, and the electron emissive layer 313 is a carbon nanotube film. Accordingly, when a driving voltage of 500˜25000V is applied to form an electric field between the cathode electrode 312 and the anode electrode (not shown in the figure), the tunnel effect occurs so as to release electrons from the electron emissive layer 313. Then, the released electrons will impact the fluorescent layer of the anode 32 to allow the fluorescent layer to emit white light.

Although the present invention has been explained in relation to its preferred embodiment, it is to be understood that many other possible modifications and variations can be made without departing from the spirit and scope of the invention as hereinafter claimed.

What is claimed is:

1. A device with electron beam excitation for making a white light source, comprising:
an electron emissive layer for providing an electron beam; and
a fluorescent layer comprising a fluorescent powder, wherein the fluorescent powder comprises at least four elements of Zn, S, Se and O, and the fluorescent layer is excited by the impact of the electron beam to thereby emit white light.

2. The device with electron beam excitation as claimed in claim 1, wherein the fluorescent powder of the fluorescent layer is prepared by a solid-reaction method.

3. The device with electron beam excitation as claimed in claim 1, wherein the fluorescent layer emits white light of continuous wavelength from 470 nm to 670 nm.

4. The device with electron beam excitation as claimed in claim 1, further comprising a first substrate, a second substrate, a cathode electrode and an anode electrode, wherein the anode electrode is formed on the surface of the first substrate, the fluorescent layer is formed on the surface of the anode electrode, the cathode electrode is formed on the surface of the second substrate, and the electron emissive layer is formed on the surface of the cathode electrode.

5. The device with electron beam excitation as claimed in claim 1, wherein the electron beam is produced by applying a driving voltage of 500˜25000 V.

6. The device with electron beam excitation as claimed in claim 1, wherein the electron beam impacts the fluorescent layer in a degree of vacuum that ranges from 10×10⁻³ to 10×10⁻⁸.

7. The device with electron beam excitation as claimed in claim 1, wherein the electron emissive layer is a carbon nanotube film.
